(19) United States
(12) Patent Application Publication
(10) Pub. No.: US 2016/0263430 A1
(43) Pub. Date: Sep. 15, 2016

(54) HULAJBIEGA WHEELED VEHICLE

(71) Applicant: DECYLION SP. Z O.O., Warszawa (PL)

(72) Inventor: MARCIN GROCHOWINA, RZESZÓW (PL)

(73) Assignee: DECYLION Sp. z o.o., WARSZAWA (PL)

(21) Appl. No.: 14/433,990

(22) PCT Filed: Oct. 31, 2014
(86) PCT No.: PCT/PL2014/000120

§ 371 Date: Apr. 7, 2015

(30) Foreign Application Priority Data
Sep. 30, 2014 (PL) P.409657

(51) Int. Cl. A63B 22/02; A63B 22/20; B62M 1/34; A63B 22/00

(52) U.S. Cl. CPC A63B 22/0207; A63B 22/0023; A63B 22/20; B62M 1/34

(57) ABSTRACT

The “Hulajbiega” for rehabilitation and training, comprising a driven track belt made in the form of the endless belt tightened on rollers, lifting mechanism used to change the training load and the handrail to facilitate balancing is characterized in that it comprises the running track fixed to the frame (1), and roller system (3.5), drive shaft (4) and lifting system 7 installed between the foot and the frame for changing the slope of the track belt.

Preferably, the belt (2) of the running track has a wedge-shaped ridge on the inner side with a shape corresponding to the groove in the roller (3.5) and the landings for foot for on both sides of the track (2).

The invention relates to a wheeled vehicle with a track called “hulajbiega”, designed in particular for rehabilitation and training.

Recent researches in the field of physical fitness rehabilitation of people after accidents or certain diseases and also in sport training, show a more rapid achievement of results by subjecting the human body to vibrations at certain frequencies and amplitudes. The first studies on the positive impact of vibration on the human body have been conducted by Nazarov in the seventies of the twentieth century. Their results are the basis for vibration training, which has become a regular part of the preparation of Soviet cosmonauts and athletes. At present, vibration training is used in all major centers of training, preparing the athletes for major competitions.
The vibration training is based on neuromuscular stimulation of the human body by mechanical vibration. The training consists in performing the exercises assigned by the instructor on a device that generates vibrations. These vibrations have properly selected parameters that meet safety requirements. Most often, the vibration frequency is in the range of 20 to 60 Hz, and the amplitude in the range of 2 to 4 mm. Various kinds of platforms for training the legs and maintaining equilibrium are mainly used in boxing training, but also for the rehabilitation of imbalances and mobility. These solutions are commonly used in various types of platforms, but not used in the most common training devices, which are tracks fitted with endless belts.
U.S. Pat. No. 5 984 838 presents a device that consists of a load-carrying frame supported from one side with non-slip feet, and on the other side with wheels for easy movement of the machine. There is an endless belt driven by muscle strength of a trainee stretched on the rolls placed at the end of the frame. The track is fitted with a handrail forming a supporting point of a trainee.
In turn, U.S. Pat. No. 2007/0 142 183 discloses a similar device, wherein the movement of the endless belt is forced by an electric motor transmitting drive onto the tensioning roller via a belt transmission. This device is adapted to generate vibrations in a longitudinal direction and the transmission belt vibrations are produced by variations in the direction of rotation of the motor driving the endless belt.

The aim of the invention is to provide a simple structure, which allows transmitting the muscle strength into the torque of wheels differently than in the classic bicycle—not by means of a connecting rod and a chain transmission, but through a running track installed on the vehicle frame.

The invention is characterized in that it comprises a running track attached to the frame.

Preferably, the track belt has a wedge-shaped ridge on the internal side with a shape corresponding to a groove in the roller, which determines the transverse position of the track belt. The wedge ridge is located inside the groove in the roller, so that they cooperate during operation of the track.
Preferably, the track has landings on both sides of the track belt that allow the trainee a short break by going out of the moving track belt.

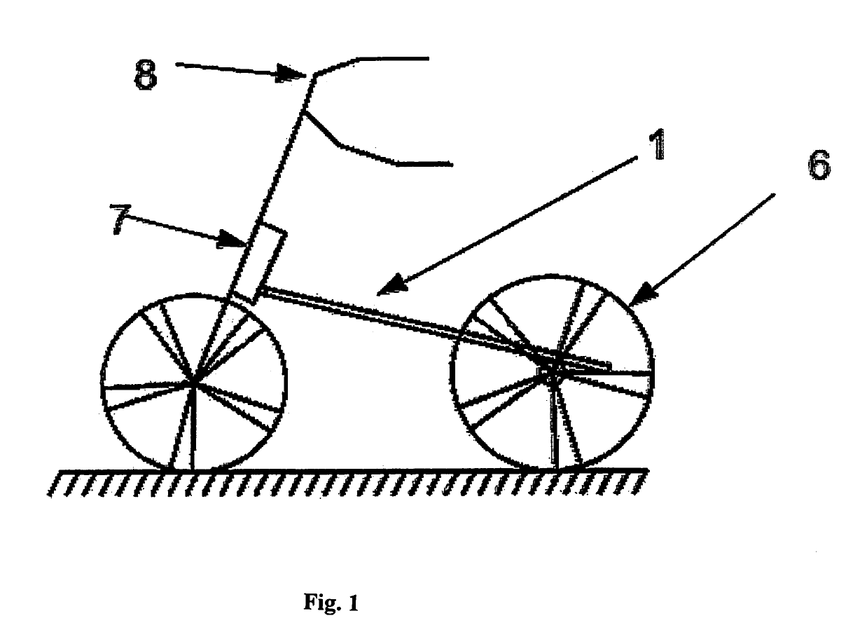

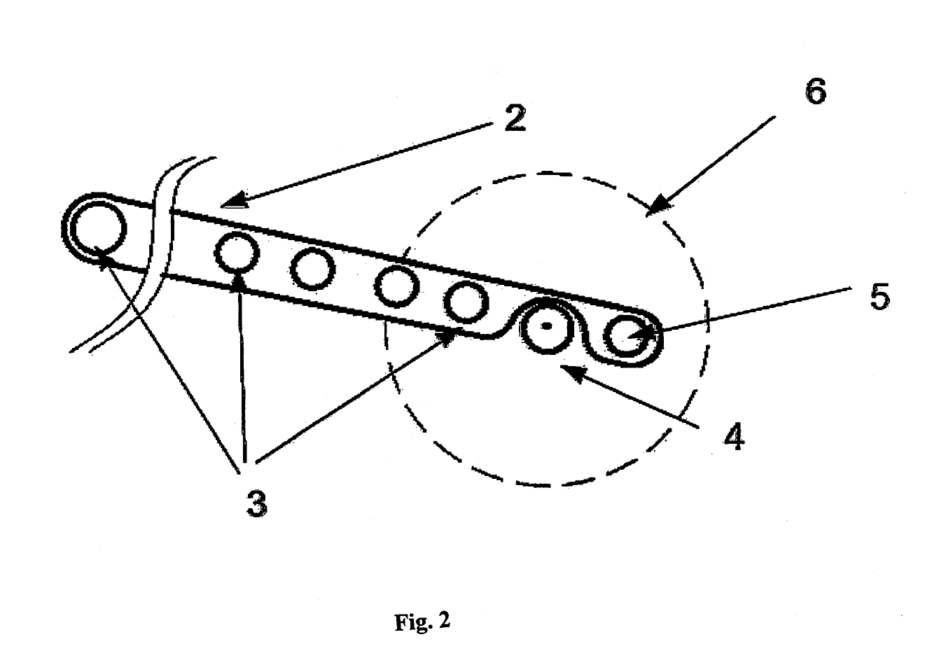

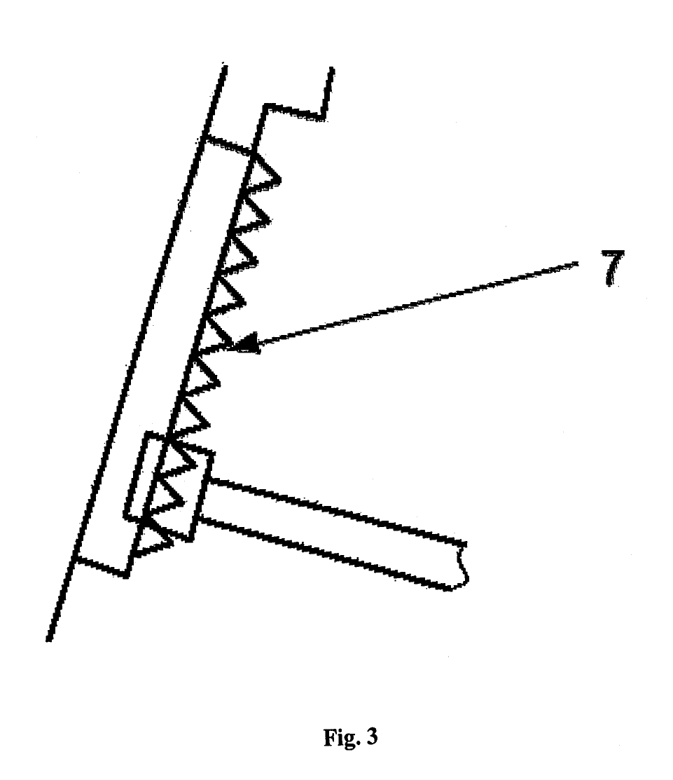

The “Hulajbiega” is shown in the exemplary embodiment in the drawing, in which FIG. 1 shows the basic components of the training track in a side view, FIG. 2 shows a cross-sectional view of the track and FIG. 3 schematically shows the lifting system.

The “Hulajbiega” consists of a frame 1 on which the basic operating components of the track are mounted, such as the track belt 2 made in the form of an endless belt, tensioned on the rollers 3,5 together with the driving shaft 4. The additional component is a lifting system 7 installed between the foot and frame for changing the slope of the track belt so that it is possible to train with a greater load—going “upward” and “downward”.

Increasing public awareness of the need to maintain good physical fitness stimulates the need for physical activity among people. In addition to the gym, the most often practiced sport disciplines are running and cycling, and a rapidly growing infrastructure, especially in the larger cities, promotes the activity of more and more people. Each of these disciplines requires the involvement of other muscles and shapes musculature in a slightly different way and may, in special cases, adversely affect the body (i.e. running along the wrong, too hard substrate has a devastating impact on the joints especially the knee). At the same time you can observe a trend to a willing—especially among young people—reaching for non-standard and innovative forms of physical activity. There is no available solution on the market that combines the benefits of running and cycling.

The solution of the invention combines two sports and the applied device is the wheeled vehicle driven by human muscle strength, and as such can be classified as a bicycle. However, the conversion of muscle strength into torque of wheels occurs otherwise than in a classic bike—not with the help of the connecting rod and chain transmission, but through the running track installed on the vehicle frame 1. The runner running on the track pushes the transmission belt of the track with his legs to the back, and the proper system of rollers 3.5 converts the sliding motion of the track into the rotation of the wheels 6. The vehicle steering is done via the classic handlebar 8 which additionally provides the support and static point of the runner in relation to the vehicle. Adjusting the angle of the track slope relative to the level enables the simulation of the run on an inclined surface, and the material from which the track is made provides optimal elasticity for damping shocks that may have an adverse impact on knee joints.

1. The “Hulajbiega” for rehabilitation and training, comprising a driven track belt made in the form of the endless belt tightened on rollers, lifting mechanism used to change the training load and the handrail to facilitate balancing characterized in that it comprises the running track fixed to the frame (1), and roller system (3.5), drive shaft (4) and lifting system 7 installed between the foot and the frame for changing the slope of the track belt.

2. The track of claim. 1, characterized in that the belt (2) of the running track has a wedge-shaped ridge on the inner side with a shape corresponding to the groove in the roll (3.5) and landings for foot on both sides of the belt (2).
